(19) United States
(12) Patent Application Publication
(10) Pub. No.: US 2015/0049103 A1
(43) Pub. Date: Feb. 19, 2015

(54) CONTROL CIRCUIT FOR FRAME MEMORY, DISPLAY DEVICE INCLUDING THE SAME AND METHOD OF CONTROLLING THE SAME

(71) Applicant: SAMSUNG DISPLAY CO., LTD., Yongin-City (KR)

(72) Inventors: Masayuki KUMETA, Yokohama (JP); Ryo ISHII, Yokohama (JP); Kazuhiro MATSUMOTO, Yokohama (JP); Shinji YAMASHITA, Yokohama (JP); Ansu LEE, Yongin-si (KR)

(21) Appl. No.: 14/526,692

(22) Filed: Oct. 29, 2014

Related U.S. Application Data
(63) Continuation of application No. PCT/JP2013/061259, filed on Apr. 16, 2013.

(30) Foreign Application Priority Data
May 1, 2012 (JP) 2012-104951

(51) Int. Cl. G09G 5/39

(52) U.S. Cl. CPC G09G 5/39; G09G 2360/12
USPC 345/534

(57) ABSTRACT

A control circuit for a frame memory includes a divider, a frame memory, a read control circuit, and a write control circuit. The divider divides image data into subfield data according to a plurality of subfields, where the image data is provided in synchronization with a first synchronization signal and in a unit of a frame. The frame memory has a plurality of blocks to store the subfield data. The read control circuit sequentially reads the subfield data from the blocks in synchronization with a second synchronization signal. The write control circuit writes new data to a first block before data written in a second block is read, and after data written in the first block is read by the read control circuit. The second synchronization signal may have a same cycle as the first synchronization signal and may be delayed by a preset delay time.

### CROSS-REFERENCE TO RELATED APPLICATIONS

This application is a continuation of pending International Application No. PCT/JP2013/061259, entitled “Control Circuit for Frame Memory, Display Device Including the Same and Method of Controlling the Same,” filed on Apr. 16, 2014, the entire contents of which are hereby incorporated by reference. In addition, Japanese Patent Application No. 2012-104951, filed on May 1, 2012, and entitled: “Control Circuit for Frame Memory, Display Device Including the Same and Method of Controlling the Same,” is incorporated by reference herein in its entirety.

### BACKGROUND

1. Field

One or more embodiments described herein relate to a control circuit for a frame memory, a display device including a control circuit for a frame memory and a method for controlling the control circuit and display device.

2. Description of the Related Art

A variety of displays have been developed. Examples include a liquid crystal display, an electro-luminescence display, and a plasma display. These displays may use a frame memory that maintains image data on a frame basis.

These displays may be driven using a field sequential driving method that sequentially drives a plurality of subfields. In this method, the write timing of image data in the frame memory is different from the read timing of this data. As a result, a read address may overtake a write address. When this occurs, a portion of an image of another frame may be displayed in a present frame. This will deteriorate display quality.

### SUMMARY

In accordance with one embodiment, a control circuit for a frame memory includes a division circuit to divide image data into a plurality of subfield data according to a plurality of subfields, the image data to be provided in synchronization with a first synchronization signal and in a unit of a frame; a frame memory having a plurality of blocks to which the subfield data is to be written; a read control circuit to sequentially read the subfield data from the blocks in synchronization with a second synchronization signal, the second synchronization signal having substantially a same cycle as the first synchronization signal and delayed by a preset delay time; and a write control circuit to write new data to a first block among the plurality of blocks before data written in a second block among the plurality of blocks is read, and after data written in the first block is read by the read control circuit.

The preset delay time may be 1-(1/n) frame period, where n is a number of the subfields. A number of the plurality of blocks may be based on a power of n, where n is the number of subfields. The second synchronization signal may be generated from the first synchronization signal.

In accordance with another embodiment, a display device includes a division circuit to divide image data into a plurality of subfield data according to a plurality of subfields, the image data to be provided in synchronization with a first synchronization signal and in a unit of a frame; a frame memory having a plurality of blocks to which the subfield data is to be written; a read control circuit to read data corresponding to one frame in synchronization with a second synchronization signal, the second synchronization signal having substantially a same cycle as the first synchronization signal and is delayed by a preset delay time, the read control circuit to read the data in a predetermined sequence; a write control circuit to write the subfield data to a first block of the plurality of blocks after the image data is read from the first block by the read control circuit; and a driving circuit to drive a pixel of a display panel based on image data read by the read control circuit.

The preset delay time may be 1-(1/n) frame period, where n is a number of the subfields. A number of the plurality to blocks may be based on a power of n, where n is the number of subfields. The second synchronization signal may be generated from the first synchronization signal.

In accordance with another embodiment, a method of controlling a frame memory includes dividing image data into a plurality of subfield data according to a plurality of subfields, the image data provided in synchronization with a first synchronization signal and in a unit of a frame; sequentially reading the subfield data from a plurality of blocks of a frame memory in synchronization with a second synchronization signal, the second synchronization signal having substantially a same cycle as the first synchronization signal and delayed by a preset delay time; and writing new data to a first block among the plurality of blocks before data written to a second block among the plurality of blocks is read, and after image data written to the first block is read. The preset delay time may be 1-(1/n) frame period, where n is a number of the subfields. A number of the plurality of blocks of the frame memory may be based on a power of n, where n is the number of subfields.

In accordance with another embodiment, a control circuit for a frame memory includes a frame memory having a plurality of blocks to store subfield data; a read control circuit to read the subfield data from the blocks in synchronization with a second synchronization signal, the second synchronization signal delated by a preset delay time relative to a first synchronization signal to control writing of the subfield data in the blocks; and a write control circuit to write new data to a first block among the plurality of blocks before data written in a second block among the plurality of blocks is read, and after data written in the first block is read by the read control circuit.

The second synchronization signal may have substantially a same cycle as a first synchronization signal. The control circuit may include a divider to divide image data into the subfield data according to a plurality of subfields, the image data to be provided in synchronization with the first synchronization signal and in a unit of a frame. The preset delay time may be 1-(1/n) frame period, where n is a number of the subfields. A number of the plurality to blocks may be based on a power of n, where n is the number of subfields. The second synchronization signal may be generated from the first synchronization signal. The read control circuit may sequentially read the data of the subfield data.

The control circuit may include an address control circuit to set a common address for a data write operation and a data read operation for one of the blocks. The read control circuit may read data from the one of the blocks and the write control circuit may write data to the one of the blocks based on the common address.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display device;

FIG. 2 illustrates an example of a data transmission order from an image transmission source in FIG. 1;

FIG. 3 illustrates a timing chart of examples of data write and read operations in the display device in FIG. 1;

FIG. 4 illustrates switch on or off of a display pixel using a field sequential driving method according to one embodiment;

FIG. 5 illustrates an example of division control of image data in the display device of FIG. 1;

FIG. 6 illustrates a timing chart of an example of a frame memory control operation according to an embodiment;

FIG. 7 illustrates a timing chart of an example of a frame memory control operation according to an embodiment;

FIG. 8 illustrates an embodiment of a flow chart of write and read operations of image data according to an embodiment 1;

FIG. 9 illustrates an embodiment of a flow chart of increment processing in FIG. 8;

FIG. 10 illustrates an example of a relationship between image display and a write state of image data relative to RAM blocks according to one embodiment;

FIG. 11 illustrates a relationship between image display and a write state of image data relative to RAM blocks according to another embodiment;

FIG. 12 illustrates a timing chart of examples of data write and read operations in a vertical direction in a display device according to another embodiment;

FIG. 13 illustrates a timing chart of an example of a frame memory control operation according to another embodiment;

FIG. 14 illustrates a timing chart of an example of a frame memory control operation according to another embodiment;

FIG. 15 illustrates a timing chart of an example of a frame memory control operation according to another embodiment;

FIG. 16 illustrates an example of a relationship between image display and the write state of image data relative to RAM blocks according to another embodiment; and

FIG. 17 illustrates an example of a relationship between image display and a write state of image data relative to RAM blocks according to another embodiment.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawing figures, the dimensions of layers and regions may be exaggerated for clarity of illustration. Like reference numerals refer to like elements throughout.

### First Embodiment

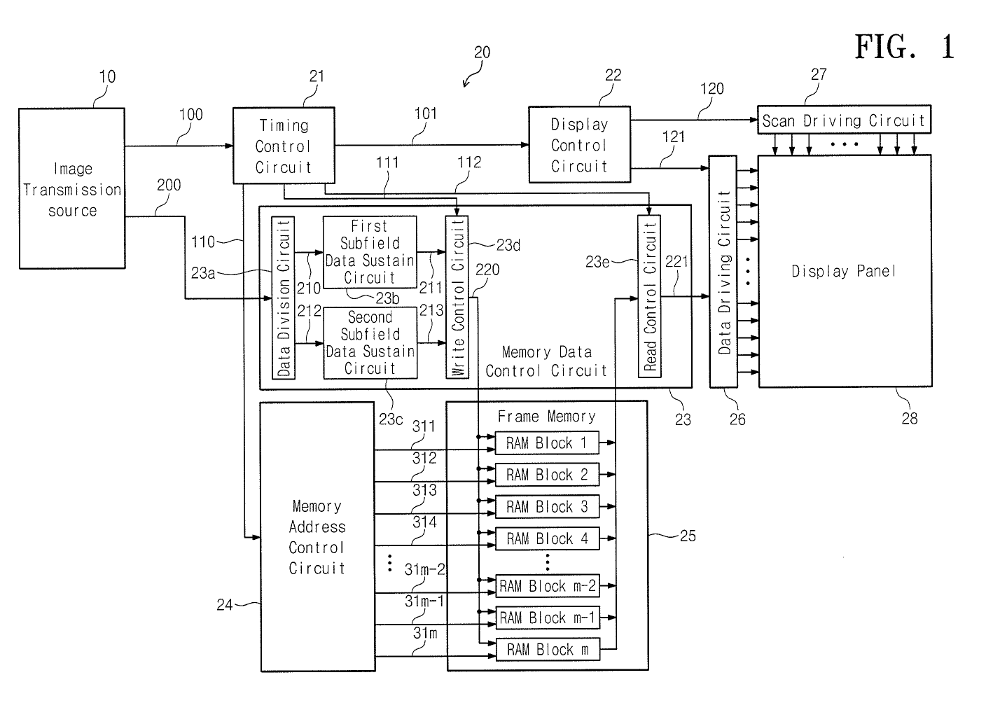

FIG. 1 illustrates an embodiment of a display device 200 which includes a timing control circuit 21, a display control circuit 22, a memory data control circuit 23, a memory address control circuit 24, a frame memory 25, a data driving circuit 26, a scan driving circuit 27, and a display panel 28.

The timing control circuit 21 generates a second vertical synchronization signal 101 that sets the timing of the read operation of image data, a write control signal 111 and a read control signal 112 that control the write operation and read operation relative to image data of a frame memory 25, and an address control signal 110 that controls operations of setting addresses used for a write operation and a read operation.

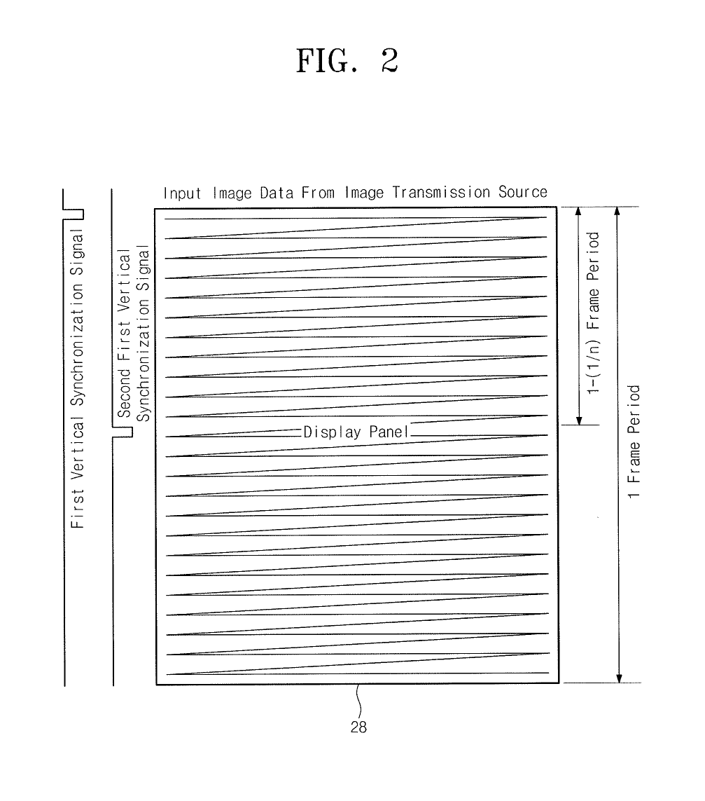

The second vertical synchronization signal 101, the write control signal 111, the read control signal 112, and the address control signal 110 are generated in synchronization with a first vertical synchronization signal 100 input from an image transmission source 10. The first vertical synchronization signal 100 defines the frame period (as shown in FIG. 2) of a frame.

The timing control signal 21 outputs the second vertical synchronization signal 101 to the display control circuit 22, outputs the write control signal 111 and the read control signal 112 to the memory data control circuit 23, and outputs the address control signal 110 to the memory address control circuit 24.

In this embodiment, the first vertical synchronization signal 100 and the second vertical synchronization signal 101 are set to have the same cycle. Also, the second vertical synchronization signal 101 is set to be synchronized with the first vertical synchronization signal 100 and delayed by 1-(1/the number of subfields) frame period. The number of subfields may be n, where in this embodiment n=2.

The memory data control signal 23 includes a data division circuit 23a, a first subfield data sustain circuit 23b, a second subfield data sustain circuit 23c, a write control circuit 23d, and a read control circuit 23e.

The data division circuit 23a divides frame-based image data 200, input from the image transmission source 10, on a subfield basis. As an example, the data separation circuit 23a divides input frame-based image data 200 into first subfield data 210 and second subfield data 212. The data division circuit 23a outputs the first subfield data 210 obtained through division to the first subfield sustain circuit 23b and outputs the second subfield data 212 obtained through division to second subfield data sustain circuit 23c.

The first subfield data sustain circuit 23b sustains the first subfield data 210 input from the data division circuit 23a. The second subfield data sustain circuit 23c sustains the second subfield data 212 input from the data division circuit 23a.

The write control circuit 23d reads the first subfield data 211 or the second subfield data 213 sustained in the first subfield data sustain circuit 23b or the second sub filed data sustain circuit 23c in synchronization with the write control signal 111 input from the timing control circuit 21 and then transmits the first subfield data 211 or the second subfield data 213 as write data 220 to the frame memory 25.

The read control circuit 23e sequentially reads the write data 220 written to the frame memory 25 in synchronization with the read control signal 112 input from the timing control circuit 21, and then sequentially transmits read write data 220 as read data 221 to the data driving circuit 26.

The memory address control circuit 24 generates memory address signals 311, 312, . . . , 31m-2, 31m-1, and 31m that set an address referenced when the write data 220 is written to the frame memory 25, and an address referenced when the write data 220 is read from the frame memory 25, and outputs generated memory address signals to the frame memory 25. The memory address signals 311, 312, . . . , 31m-2, 31m-1, and 31m are generated according to the address control signal 110 input from the timing control circuit 21.

In this embodiment, an address for a data write operation and an address for a data read operation are set in common, data is read from the frame memory 25 with reference to a set address, and then data is written to the frame memory 25 with reference to the address set in common.

The frame memory 25 is divided into a plurality of RAM blocks. As an example, the plurality of RAM blocks include RAM block 1 to RAM block m. The number of RAM blocks 1 to m may be set to the power of the number of subfields. As another example, the number of RAM blocks 1 to m may be a value obtained by multiplying the power of the number of subfields by (1-1/n).

By the memory address signals 311, 312, . . . , 31m-2, 31m-1, and 31m, the write data sequentially transmitted from the write control circuit 23d are sequentially written to RAM blocks 1 to m.

The write data 220 written to each of RAM blocks 1 to m is sequentially transmitted to the read control circuit 23e by the memory address signals 311, 312, . . . , 31m-2, 31m-1, and 31m generated from the memory address control circuit 24.

The display control circuit 22 generates a scan control signal 120 and a data control signal 121 based on the second vertical synchronization signal 101 input from the timing control signal 21 and outputs generated signals to the scan driving circuit 27. Then, the display control circuit 22 outputs the data control signal 121 to the data driving circuit 26. The scan driving circuit 27 scan-drives a plurality of display pixels arranged in the display panel 28 by the control of the scan control signal 120 input from the display control circuit 22.

The data driving circuit 26 provides the plurality of display pixels arranged in the display panel 28 with the read data 221 transmitted from the read control circuit 23e by the control of the data control signal 121 input from the display control circuit 22. The plurality of display pixels display images corresponding to the read data 221 received.

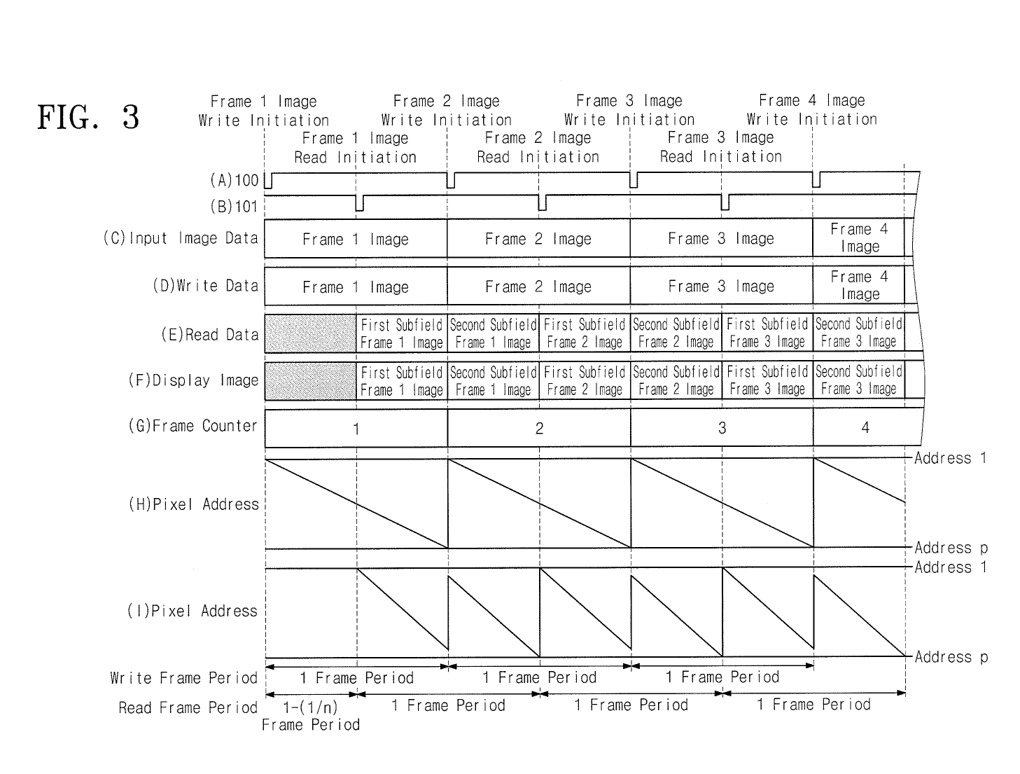

The display panel 28 uses a display device having a pixel configuration arranged in a matrix shape such as a liquid crystal display, an organic EL display, or a plasma display. In this example, the write timing of the write control circuit 23d and the read timing of the read control circuit 23e of the present embodiment are described with reference to FIGS. 2 and 3.

FIG. 2 illustrates an example of a data transmission order from the image transmission source in FIG. 1. FIG. 3 is a timing chart of examples of write and read operations and represents an example of a field sequential driving method.

The writing of the write data 220 to the frame memory 25 is initiated in synchronization with the first vertical synchronization signal 100 output from the image transmission source 10. The operation of reading the write data 220 from the frame memory 25 is initiated in synchronization with the second vertical synchronization signal 101 generated from the first vertical synchronization signal 100 by the timing control circuit 21. Each of write and read operations for one frame is completed within one frame period.

The second vertical synchronization signal 101 is a signal obtained by delaying the first vertical synchronization signal 100 by 1-(1/n) frame. For example, the read operation is initiated after a 1-(1/n) frame period (in this example, a 1/2 frame) delay from the initiation of the write operation.

In FIG. 3, part (H) represents the address of a pixel at each timing point of image data 200 (of parts (C) and (D) of FIG. 3) written to the frame memory 25. As an example, the address of a pixel includes addresses 1 to p. For example, the address 1 may correspond to an upper left pixel and the address p may correspond to a lower right pixel. In FIG. 3, part (I) represents the address of a pixel at each timing point of image data (of part (E) of FIG. 3) read from the frame memory 25.

### Circuit Operation

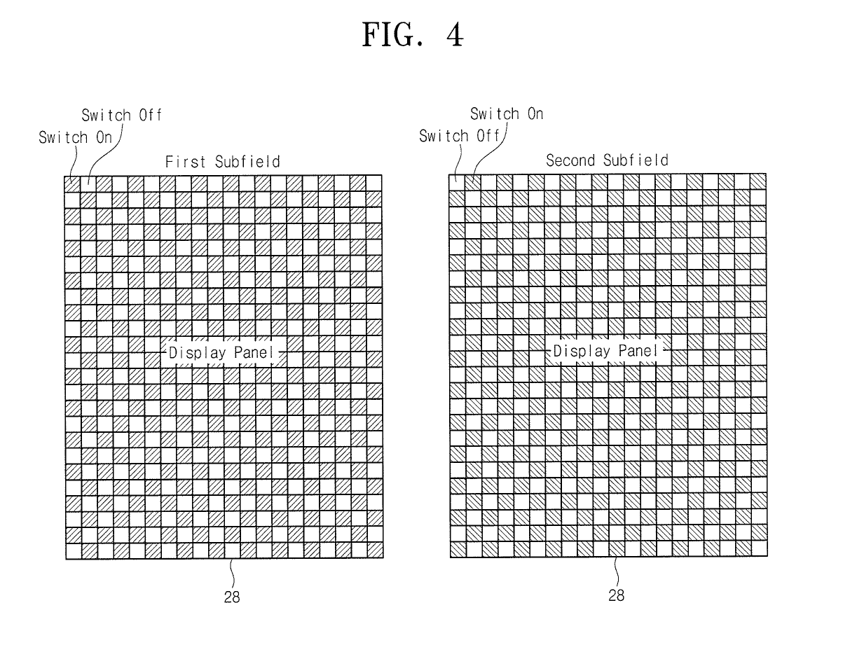

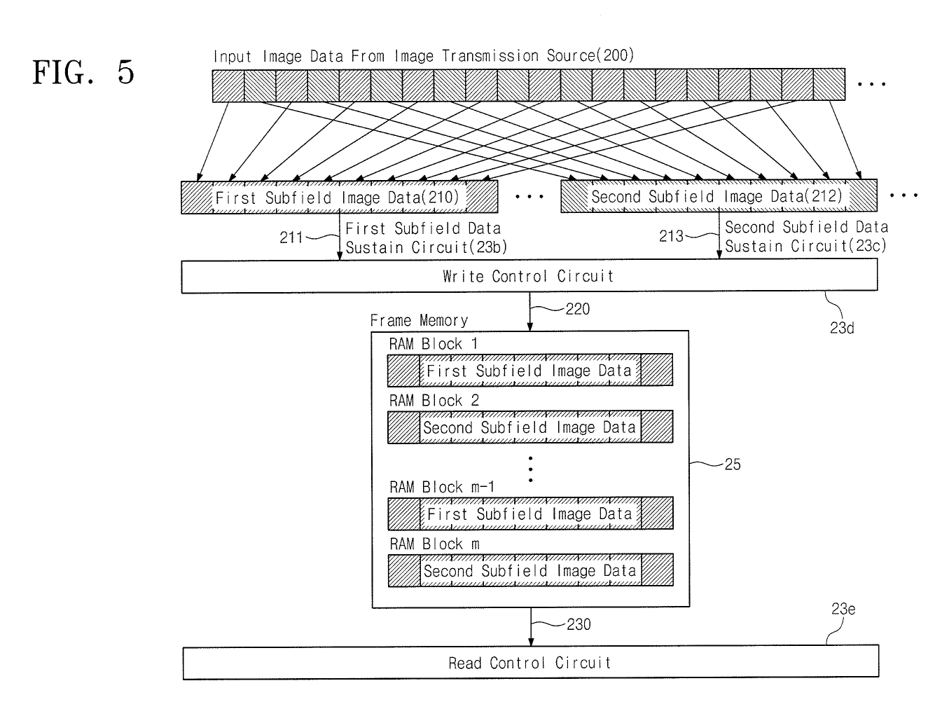

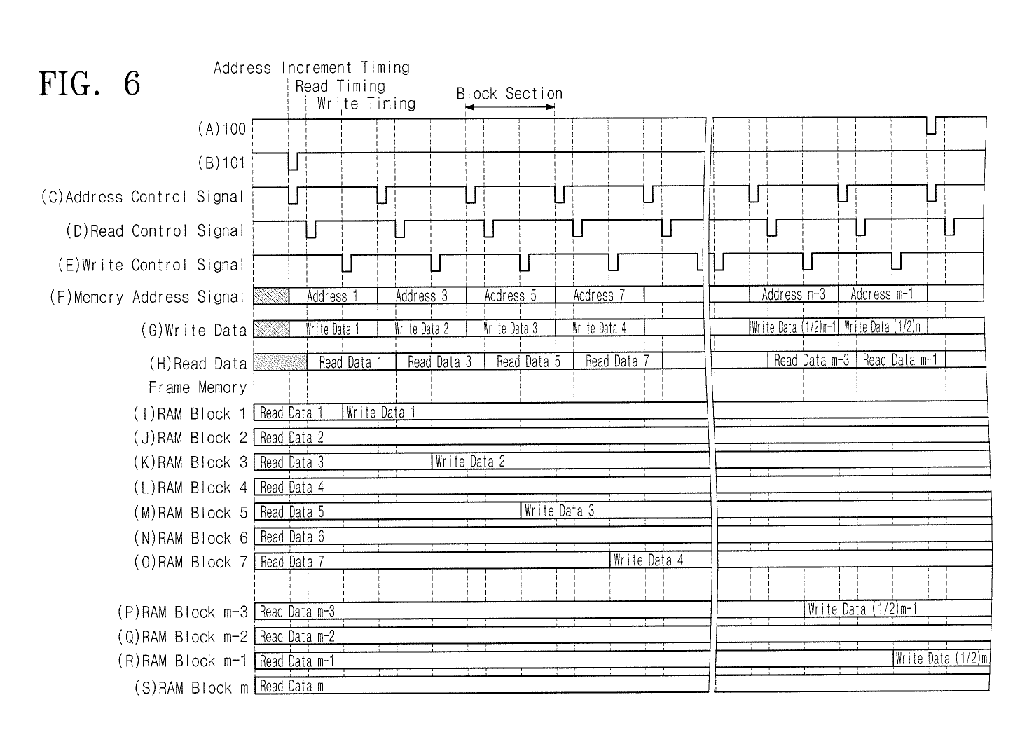

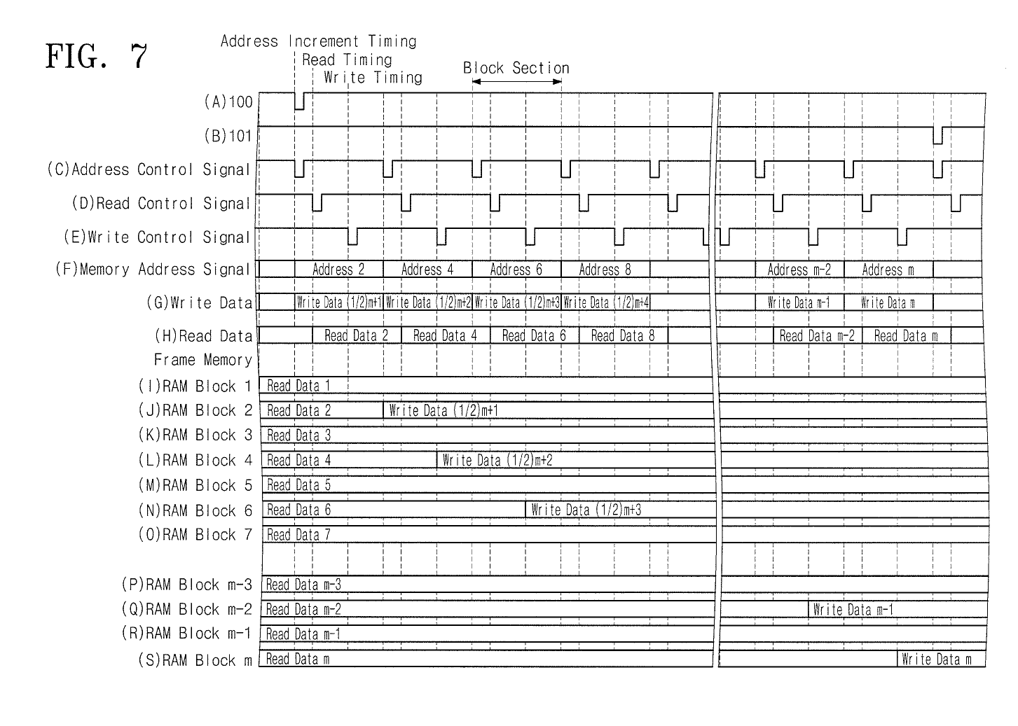

Embodiments of the write and read operations of image data in the display device 20 of FIG. 1 are described with reference to FIGS. 4 to 7. FIG. 4 represents images generated by the switch on or off of display pixels in field sequential driving control. FIG. 5 represents an example of the division control of image data in the display device of FIG. 1. FIGS. 6 and 7 are timing charts of examples of a frame memory control operation.

FIG. 4 represents images displayed in a first subfield and a second subfield by the display pixels of the display panel 28, with first subfield data and second subfield data sustained in the frame memory 25. The images displayed by the display pixels in the first and second subfields have a pattern (checkerboard pattern) in which each pixel is alternately switched on and off.

A pixel displaying an image among the display pixels of the display panel 28 is driven in each subfield by the data driving circuit 26 and the scan driving circuit 27. An image display operation performed by the display panel 28 is described with reference to FIGS. 5 to 7.

First, the division control operation of image data is described with reference to FIG. 5. In FIG. 5, the image data is transmitted to the data division circuit 23a as input image data in synchronization with the first vertical synchronization signal 100 from the image transmission source 10. The image data is transmitted to the data division circuit 23a continuously according to an image.

The input image data 200 is divided on a subfield basis by the data division circuit 23a, and is sustained by the first subfield data sustain circuit 23b and the second subfield data sustain circuit 23c as the first sub filed data 210 and the second subfield data 212 as shown in FIG. 5.

Then, the first subfield data 210 sustained in the first subfield data sustain circuit 23b and the second subfield data 212 sustained in the second subfield data sustain circuit 23c are read by the write control circuit 23d as the first subfield data 211 and the second subfield data 213, and are sequentially transmitted to the frame memory 25 as the write data 220 in synchronization with the write control signal 111.

The write data 220 transmitted to the frame memory 25 is sequentially written to RAM blocks 1 to m corresponding to addresses determined by the memory address signals 311, 312, . . . , 31m-2, 31m-1, and 31m. In this case, only one of the first subfield data 210 or the second subfield data 212 is written and both data are not simultaneously written.

The write data 220 written to RAM blocks 1 to m is sequentially read from RAM blocks 1 to m corresponding to addresses determined by the memory address signals 311, 312, . . . , 31m-2, 31-1, and 31m and transmitted to the read control circuit 23e. The read control circuit 23e is sequentially transmitted to the data driving circuit as the read data 221 in synchronization with the read control signal 112 by the read control circuit 23e.

In this example, the write control circuit 23d and the read control circuit 23e use the memory address signal 311, 312, . . . , 31m-2, 31m-1, or 31m in common and are controlled to operate in the read order of the read control circuit 23e and in the write order of the write control circuit 23d. For example, when data is read from a RAM block corresponding to any one address, then data is written to a RAM block corresponding to that address. Then, data is read from a RAM block corresponding to another address next set and new data is written to another RAM block.

In this embodiment, an address is used in common in write and read operations.

Also, since the address control circuit 24 that controls write and read operations is shared and the number of the RAM blocks is set to the power of the number of subfields n (e.g., 2″), the calculation of an address that is set when image data of each subfield is written or read is simplified. However, in another embodiment, the number of the RAM blocks may be different from the power of the number of subfields n.

The write and read operations of the image data is described in more detail with reference to FIGS. 6 and 7. FIG. 6 is a timing chart of examples of the write and read operations of image data according to the image display of a first sub field in FIG. 4.

The timing control circuit 21 initiates generation of the address control signal 110 in synchronization with the second vertical synchronization signal 101 (of part (B) of FIG. 6). The address control signal 110 is output to address control circuit 24 (see part (C) of FIG. 6). A plurality of block sections are defined by address control signal 110.

The memory address control circuit 24 sequentially generates memory address signals 311, 312, . . . , 31m-2, 31m-1, and 31m represented as a sequential increment in address in synchronization with the address control signal 110 (see part (F) of FIG. 6). The timing of an increment in address by the memory address signals 311, 312, . . . , 31m-2, 31m-1, and 31m is represented as an “address increment timing” in FIG. 6.

An address having an increment by the memory address signal represented in part (F) of FIG. 6 is to display first subfield data and the address is sequentially set to address 1 -> address 3 -> address 5 -> address 7 -> . . . -> address m-3 -> address m-1″, for example. Address 1, address 3, . . . , address m-3 to address m-1 are sustained for a plurality of block sections, respectively. For example, address 1 is sustained for a first block section and address 3 is sustained for a second block section.

Also, the first subfield data 211 sustained in the first subfield data sustain circuit 23b by the write control circuit 23d, in synchronization with the write control signal 111 represented in part (E) of FIG. 6, is sequentially transmitted to the frame memory 25 as write data 220 (write data 1 to (1/2)m represented in part (G) of FIG. 6).

FIG. 6 represents that read data 1 to m represented in parts (I) to (S) of FIG. 6, and read targets previously written to RAM blocks 1 to m before the write data 1 to (1/2)m are sequentially written to RAM block 1, RAM block 3, . . . , RAM block m-3, and RAM block m-1.

Read data 1, read data 3, . . . , read data m-3, and read data m-1, according to address 1, address 3, . . . , address m-3 to address m-1 set by the memory address signals 311, 312, . . . , 31m-2, 31m-1, and 31m among the whole read data 1 to m, is sequentially transmitted from RAM block 1, RAM block 3, . . . , RAM block m-3, and RAM block m-1 to the read control circuit 23e. The read control circuit 23e sequentially transmits read data 1, read data 3, . . . , read data m-3, and read data m-1 to the data driving circuit 26 in synchronization with the read control signal 112 represented in part (D) of FIG. 6.

Then, according to address 1, address, 3, . . . , address m-3 to address m-1 set by the memory address signals 311, 312, . . . , 31m-2, 31m-1, 31m represented in part (F) of FIG. 6, write data 1 to (1/2)m represented in part (G) of FIG. 6 is sequentially written to RAM block 1, RAM block 3, . . . , RAM block m-3, and RAM block m-1 in synchronization with the write control signal 111.

By the write and read operations of first subfield data represented in FIG. 6, the image of the first subfield represented in FIG. 4 is displayed on the display panel 28.

Then, examples of the write and read operations of image data according to the image display of the second subfield represented in FIG. 4 are described with reference to the timing chart of FIG. 7 and FIG. 1.

The timing control circuit 21 generates the address control signal 110 in synchronization with the second vertical synchronization signal 101 (of part (B) of FIG. 7) (continuously from the state of FIG. 6). The address control signal 110 is output to the memory address control circuit 24 (see part (C) of FIG. 7). A plurality of block sections is defined by the address control signal 110.

The memory address control circuit 24 sequentially generates the memory address signals 311, 312, . . . , 31m-2, 31m- 1, and 31m represented as a sequential increment in address in synchronization with the address control signal 110 (see part (F) of FIG. 7). The timing of an increment in address by the memory address signals 311, 312, . . . , 31-2, 31m-1, and 31m is represented as an “address increment timing” in FIG. 7.

An address having an increment by the memory address signal represented in part (F) of FIG. 7 is to display second subfield data and the address is set to “address 2 -> address 4 -> address 6 -> address 8 -> . . . -> address m-2> m”, for example. Also, the second subfield data 212 sustained in the second subfield data sustain circuit 23c by write control circuit 23d in synchronization with the write control signal 111 represented in part (E) of FIG. 7 is sequentially transmitted to the frame memory 25 as write data 220 (write data (1/2)m+1 to m represented in part (G) of FIG. 6).

Address 2, address 4, . . . , address m-2 to address m are sustained for a plurality of block sections, respectively. For example, address 2 is sustained for a first block section and address 4 is sustained for a second block section.

FIG. 7 represents read data 1 to m represented in parts (I) to (S) of FIG. 7, and read targets are written to RAM blocks 1 to m before the write data (1/2)m to m is sequentially written.

According to address 2, address 4, . . . , address m-2 to address m set by the memory address signals 311, 312, . . . , 31m-2, 31m-1, and 31m, read data 2, read data 4, . . . , read data m-2, and read data m among the whole read data 1 to m are sequentially transmitted from RAM block 2, RAM block 4, . . . , RAM block m-2, and RAM block m to the read control circuit 23e. The read control circuit 23e sequentially transmits read data 2, read data 4, . . . , read data m-2, and read data m to the data driving circuit 26 in synchronization with the read control signal 112 represented in part (D) of FIG. 7.

Then, by address 2, address, 4, . . . , address m-2 and address m set by the memory address signals 311, 312, . . . , 31m-2, 31m-1, and 31m represented in part (F) of FIG. 7, write data (1/2)m+1 to m represented in part (G) of FIG. 7 are sequentially written to RAM block 2, RAM block 4, . . . , RAM block m-2, and RAM block m in synchronization with the write control signal 111.

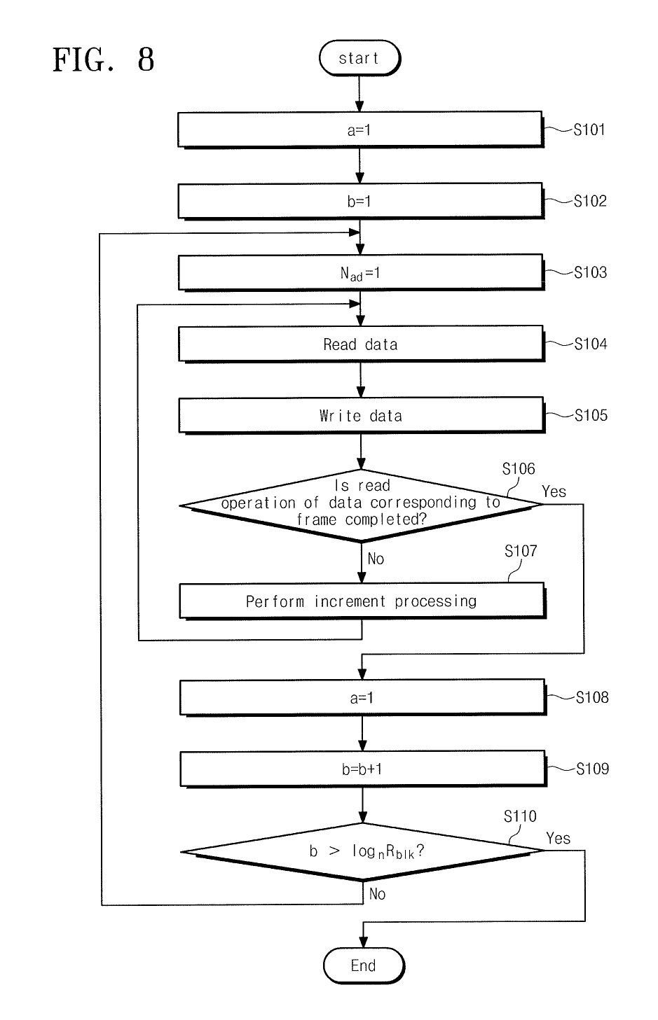

By the write and read operations of second subfield data represented in FIG. 7, the image of the second subfield represented in FIG. 4 is displayed on the display panel 28. Then, examples of the generation process of the memory address signal and the write and read processes of the image data are described with reference to FIG. 8.

In FIG. 8, the parameter “a” is an address after the determination of the condition N_{ad}>R_{blk} (hereinafter, referred to as a “condition determination count value a”), the parameter “b” is a frame count number, the parameter N_{ad} is an address (which is designated by the address control signal), and the parameter R_{blk} is the number of RAM blocks (m in the above example).

In FIG. 8, the memory address control circuit 24 first sets the address a after the determination of the condition N_{ad}>R_{blk} to “1” in operation S101, and then sets the address N_{ad} to “1” in operation S103. The memory address control circuit 24 outputs a memory address signal of which the address N_{ad} is set to 1 to the frame memory 25.

Then, the frame memory 25 reads data written to the RAM block 1 of the address N_{ad}=1 set as the memory address signal input from the memory address control circuit 24 and transmits read data to the read control circuit 23e in operation S104. Then, the frame memory 25 writes the write data 220 transmitted from the write control circuit 23d to the RAM block 1 of the address N_{ad}=1 set as the memory address signal input from the memory address control circuit 24 in operation S105.

Then, the memory address control circuit 24 determines whether the read operation of the write data 220 corresponding to one frame has been completed in operation S106. When it is determined that the write data 220 corresponding to one frame has been completed (Yes in operation S106), the process proceeds to operation S108. When it is determined that the write data 220 corresponding to one frame has not been completed (No in operation S106), the process proceeds to increment processing of operation S107.

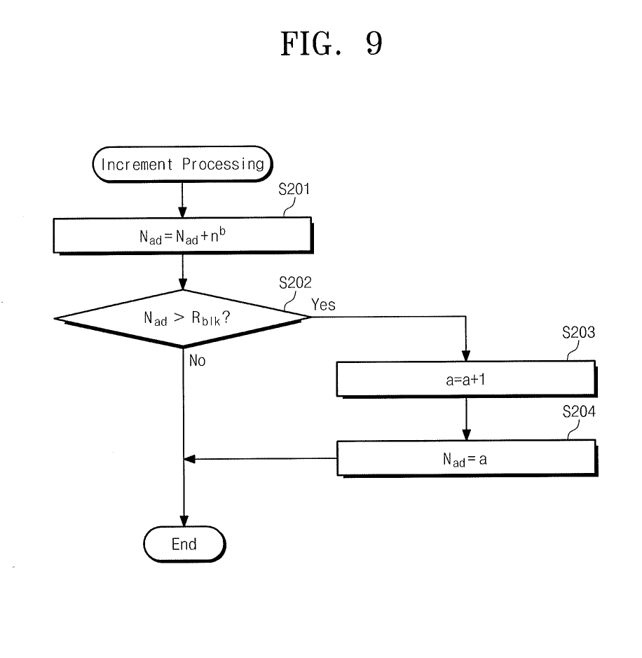

In this example, the increment processing is described with reference to a flow chart of FIG. 9. In FIG. 9, an increment n^{b} is first added to the address N_{ad}=1 in operation S201. Also, the number of subfields n is 2 in the above example. Then, it is determined whether the address N_{ad} to which the increment n^{b} has been added is larger than the number of RAM blocks R_{blk} in operation S202. When it is determined that the address N_{ad} is larger than the number of RAM blocks R_{blk} (Yes in operation S202), the process proceeds to operation S203, and when it is determined that the address N_{ad} is not larger than the number of RAM blocks R_{blk} (No in operation S202), the increment processing ends and the process proceeds to operation S104.

When it is determined that the address N_{ad} is larger than the number of RAM blocks R_{blk} (Yes in operation S202), “1” is added to the address a in operation 5203. Then, the addition result a of the address in operation S203 becomes the address N_{ad} in operation S204, the increment processing ends and the process proceeds to operation S104 of FIG. 8.

Referring back to FIG. 8, the read processing of the write data 220 from the

RAM block of the address N_{ad} having an increment is performed in operation S104 after the increment processing, and the write processing of the write data 220 relative to the RAM block of the address N_{ad} having the increment is performed in operation S105. The read processing, the write processing and the increment processing are repeated until the read processing of the write data 220 corresponding to one frame is completed.

When it is determined that the read operation of the write data 220 corresponding to one frame has been completed in operation S106 (Yes in operation S106), the memory address control circuit 24 sets the address a to “1” in operation S108. Then, the memory address control circuit 24 adds “1” to the frame count b in operation S109 and determines whether the addition result of the frame count b is larger than the number of completed frames logₙR_{blk} representing the number of frames that image display completes, in operation S110. When it is determined that the addition result of the frame count b is larger than the number of completed frames logₙR_{blk} (Yes in operation S110), the process ends, and when it is determined that the addition result of the frame count b is not larger than the number of completed frames logₙR_{blk} (No in operation S110), the process proceeds to operation S103. Also, in the flow chart of FIG. 8, when operation S110 is determined to be Yes, the process ends but while the display control of the display panel 28 based on the image data 200 continues, the process is re-initiated and the process continues from first operation S101.

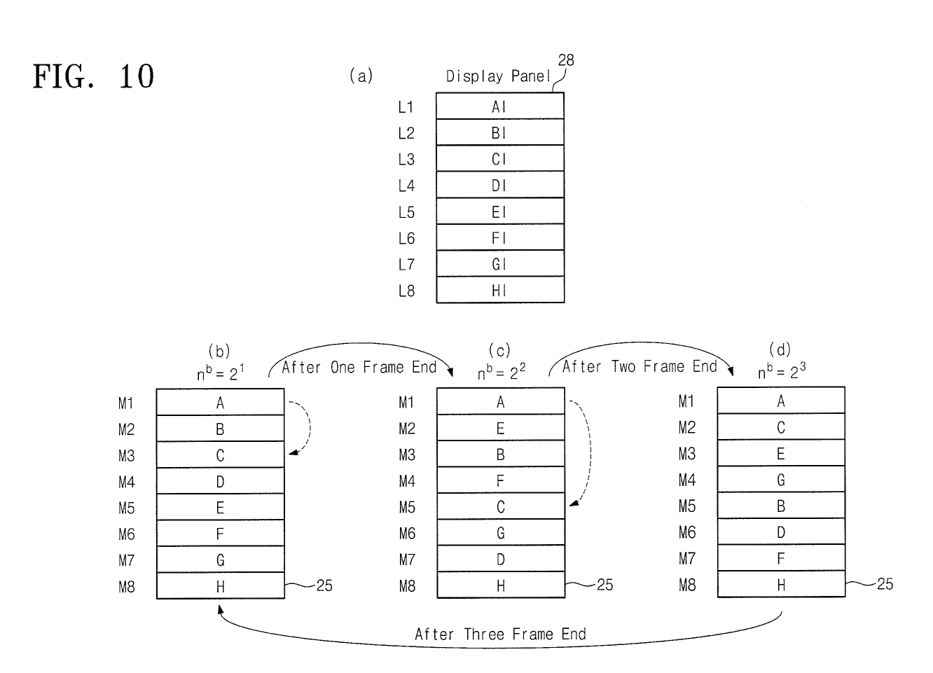

Next, a particular example of the write data 220 (as shown in FIG. 1) that is sequentially written to a RAM block according to the increment processing of an address is described with reference to FIGS. 1 and 10.

FIG. 10 illustrates an example of a relationship between image data displayed on the display panel 28 and write data written to a RAM block. For the simplicity of description, FIG. 10 represents when eight pixel addresses are provided with the display panel 28 and eight RAM blocks are provided. Also, the number of subfields n is set to 2.

The pixel addresses L1 to L8 of the display panel 28 is set in part (A) of FIG. 10 and addresses M1 to M8 are set for each RAM block of the frame memory 25 in parts (B) to (D) of FIG. 10. Images AI to HI are displayed on the pixel addresses L1 to L8 of the display panel 28. In order to display the images AI to HI, write data A to H is previously written to each RAM block corresponding to each of the addresses M1 to M8 having an increment by the address increment processing.

The write data A to H corresponds to images AI to HI, respectively. Write data A, C, E and G is the write data of a first subfield and write data B, D, F, and H is the write data of a second subfield.

First, since the frame count b is 1, the increment n^{b} becomes 2¹ and the address N_{ad} increases by 2. Therefore, data A, C, E, and G of the first subfield is sequentially read from addresses M1, M3, M5 and M7 and write data A to D of the next frame is written to these addresses M1, M3, M5 and M7, respectively.

Then, data B, D, F and H of the second subfield is sequentially read from addresses M2, M4, M6 and M8 and write data E to H of the next frame is written to these addresses M2, M4, M6 and M8, respectively. Thus, data corresponding to one frame is read. Here, each RAM block has a state as represented in part (C) of FIG. 10.

Then, since the process transits to the next frame b=2, the increment n^{b} becomes 2² and the address N_{ad} increases by 4. Therefore, data A, C, E and G of the first subfield is sequentially read from addresses M1, M5, M2 and M6 and write data A to D of the next frame is sequentially written to these addresses M1, M5, M2 and M6.

Then, data B, D, F and H of the second subfield is sequentially read from addresses M3, M7, M4 and M8 and write data E to H of the next frame is written to these addresses M3, M7, M4 and M8, respectively.

Then, since the process transits to the next frame b=3, the increment n^{b} becomes 2³. In this state, write data corresponding to addresses M1 to M8 is sequentially read and when the write data of the next frame is written, the process returns to a state that part (B) of FIG. 10 has. This corresponds to Yes in operation S110 in the flowchart of FIG. 8. In this case, the write state transition of write data relative to eight RAM blocks is repeated among three states in parts (B) to (D) of FIG. 10. In this example, the frame memory 25 may be capacity corresponding to one frame or may be 1/2 when capacity corresponding to typical two frames is needed.

In the above-described example, when the number of subfields n is 2, the read and write processing of image data and the increment processing of an address are used to perform the read and write operations of image data when the number of pixel addresses L1 to L8 is 8 and the number of RAM blocks is 8. Thus, since the frame memory 25 is enough to have capacity corresponding to one frame, the capacity of the frame memory 25 decreases to 1/2 of typical capacity.

In this case, it may be implemented without delaying the second vertical synchronization signal 101 by 1-(1/n) frame period 1/2 frame period in this example) than a first vertical synchronization signal. When it is assumed that the second vertical synchronization signal 101 is delayed by 1-(1/n) frame period (1/2 frame period in this example) than the first vertical synchronization signal, it is possible to further decrease frame memory capacity to 1-(1/n) (1/2 in this example) by setting the number of RAM blocks to 2 by using the delay.

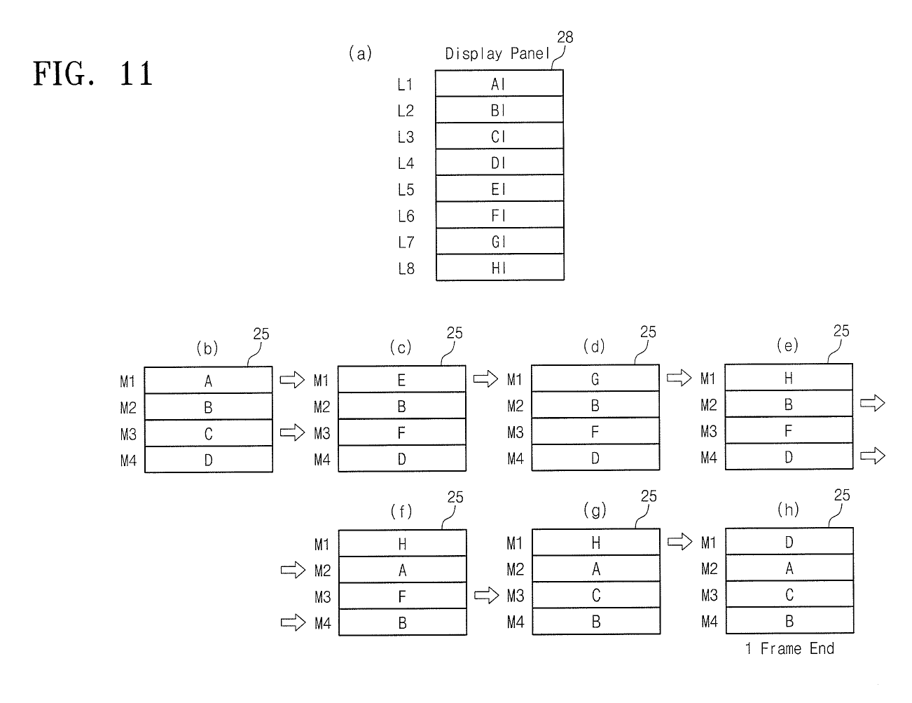

In the following, when the number of subfields n is 2, an example of performing the read and write operations of image data by setting the number of pixel addresses L1 to L8 of the display panel 28 to 8 and the number of RAM blocks to 4 is described with reference to FIGS. 1 and 11.

FIG. 11 illustrates an example of a relationship between image data displayed on the display panel 28 and write data written to four RAM blocks. For the simplicity of description, FIG. 11 represents when the number of the pixel addresses L1 to L8 of the display panel 28 is 8 and the number of RAM blocks is 4.

The pixel addresses L1 to L8 of the display panel 28 are set in part (A) of FIG. 11 and addresses M1 to M4 are set for each RAM block of the frame memory 25 in parts (B) to (H) of FIG. 11. Images AI to HI are displayed on the pixel addresses L1 to L8 of the display panel 28. In order to display the images, firstly, data A to D is sequentially written to each RAM block corresponding to each of addresses M1 to M4.

Write data A to H corresponds to images AI to HI, respectively. Write data A, C, E, and G is the write data of a first subfield and write data B, D, F, and H is the write data of a second subfield.

First, the write data of the first subfield is read. Write data A and C is sequentially read from addresses M1 and M3, respectively in part (B) of FIG. 11 and write data E and F of the same frame is written to addresses M1 and M3, respectively. In this state, each RAM block has a state as represented in part (C) of FIG. 11.

Then, write data E is read from address M1 to which write data B of the first subfield is written, and data G of the same frame is written to address M1. In this state, each RAM block has a state as represented in part (D) of FIG. 11.

Then, data G is read from address M1 and data H of the same frame is written to address M1. As such, data A, C, E and G corresponding to the first subfield is read. In this state, each RAM block has a state as represented in part (E) of FIG. 11.

Then, the data of the second subfield is read. More particularly, write data B and D is sequentially read from addresses M2 and M4 in part (E) of FIG. 11 and data A and B of the next frame is sequentially written. In this state, each RAM block has a state as represented in part (F) of FIG. 11.

Then, write data F is read from address M3 and write data C of the next frame is written to address M3. In this state, each RAM block has a state as represented in part (G) of FIG. 11.

Then, write data H is read from address M1 and write data D of the next frame is written to address M1. As such, write data B, D, F, and H corresponding to the second subfield is read. Accordingly, write data corresponding to one frame is read. In this state, each RAM block has a state as represented in part (H) of FIG. 11.

Then, even though the process transits to the next frame, write data A, C, E, and

G of the first subfield and write data B, D, F, and H of the second subfield are sequentially read as described above. In addition, whenever a read operation is performed, write data A to H of the next frame is sequentially written to a RAM block corresponding to an address from which write data is read.

More particularly, when the first frame count is 1, data written to four RAM blocks transits in the order represented in FIG. 11. Also, the order in which write data is written to four RAM blocks properly transits with a change in frame count number, and when the read and write operations of write data of one frame are completed, the process return to the initial state in which write data A to D is written.

As such, by delaying the second vertical synchronization signal 101 by 1-(1/n) frame period (1/2 frame period in this example) than a first vertical synchronization signal, it is possible to decrease the capacity of a frame memory to 1-(1/n) (1/2 in this example).

As above, the display device 20 according to the present embodiment sequentially controls the increment processing of an address, the read processing of write data, and the write processing of write data, and also sets, in common, an address setting read and write operations for control. Accordingly, it is possible to share a RAM block for the read and write operations of each subfield data obtained by dividing image data on a subfield basis, and it is possible to perform a write operation immediately after completing a read operation with respect to each RAM block. By such memory control, it is possible to decrease frame memory capacity to 1/2.

Also, it is possible to avoid the overtaking situation of an address by synchronizing the first vertical synchronization signal 100 with the second vertical synchronization signal 101 in frame period and delaying the second vertical synchronization signal 101 by 1-(1/n) frame period (1/2 frame period) than the first vertical synchronization signal 100.

Also, it is possible to efficiently use a frame memory region and, as a result, it is possible to decrease the necessary capacity of the frame memory 25. By the delay control, it is possible to decrease the capacity of the frame memory 25 to 1-(1/n)(1/2 where n=2).

The increment processing of an address, data read processing and data write processing according to the present embodiment may be applied to a field sequential driving method in which one frame is divided and driven into two subfields. By performing processing on the frame memory, frame memory capacity according to the present embodiment may decrease to capacity corresponding to a 1/2 frame through the above-described memory control and delay control. On the contrary, other configurations need memory capacity corresponding to two frames. Therefore, the display device 20 according to the present embodiment may decrease the frame memory capacity to up to 1/4 compared when these other configurations.

### Second Embodiment

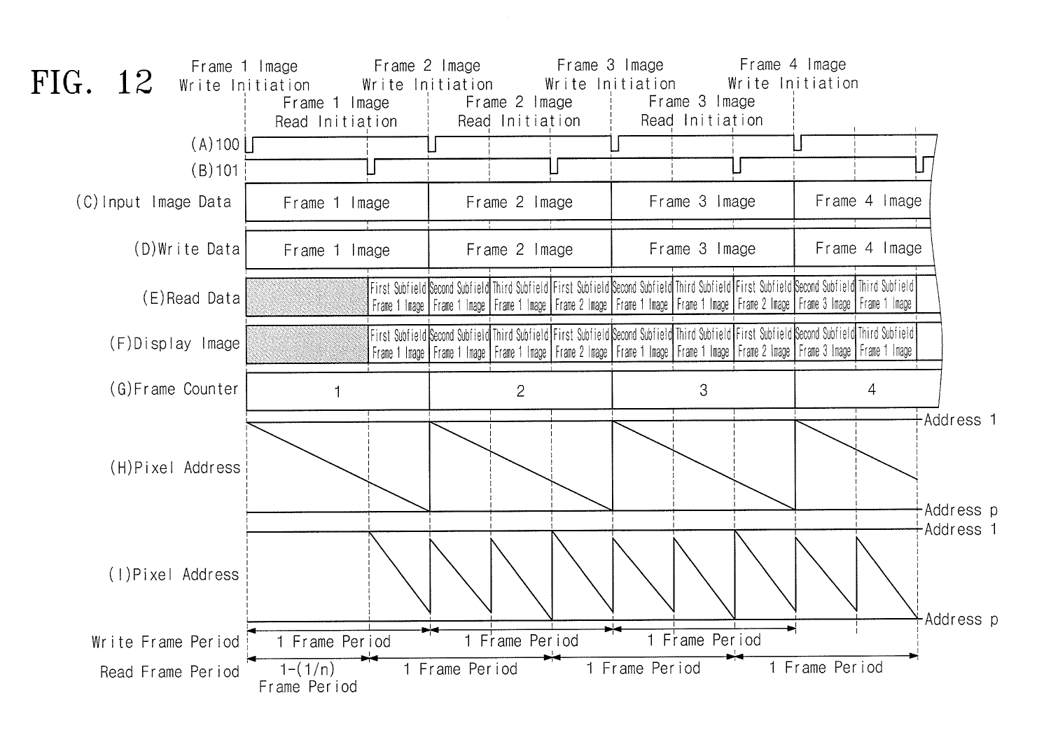

A display device according to another embodiment is described in detail with reference to FIGS. 1 and 12. In this embodiment, data write and read operations to and from a frame memory when the number of subfields is 3 are described with reference to FIGS. 12 to 15. When n=3, signal R (red pixel), signal G (green pixel), and signal B (blue pixel) are written for first to third subfields, respectively.

Also, the display device according to this embodiment includes a third subfield data sustain circuit that is not shown in the memory data control circuit 23 according to the circuit configuration of FIG. 1 according to the previous embodiment. Other components may be the same as those of the previous embodiment.

First, the transmission order of image data from the image transmission source 10 to the display panel 28 is described with reference to FIG. 1 and the timing chart of FIG. 12. The writing of the write data 220 to the frame memory 25 is initiated in synchronization with the first vertical synchronization signal 100 output from the image transmission source 10.

The operation of reading the write data 220 from the frame memory 25 is initiated in synchronization with second vertical synchronization signal 101 generated from the first vertical synchronization signal 100 by the timing control circuit 21. Each of the write and read operations for one frame is completed within one frame period.

The second vertical synchronization signal 101 is set to be delayed by 1-(1/n) frame period (2/3 frame in this example) than the first vertical synchronization signal 100 as shown in FIG. 2.

Also, as represented in FIG. 3, part (H) of FIG. 12 represents the address of a pixel at each timing point of the image data (of parts (C) and (D) of FIG. 12) written to the frame memory 25, and FIG. 1 represents the address of a pixel at each timing point of the data (of part (E) of FIG. 12) read from the frame memory 25.

### Circuit Operation

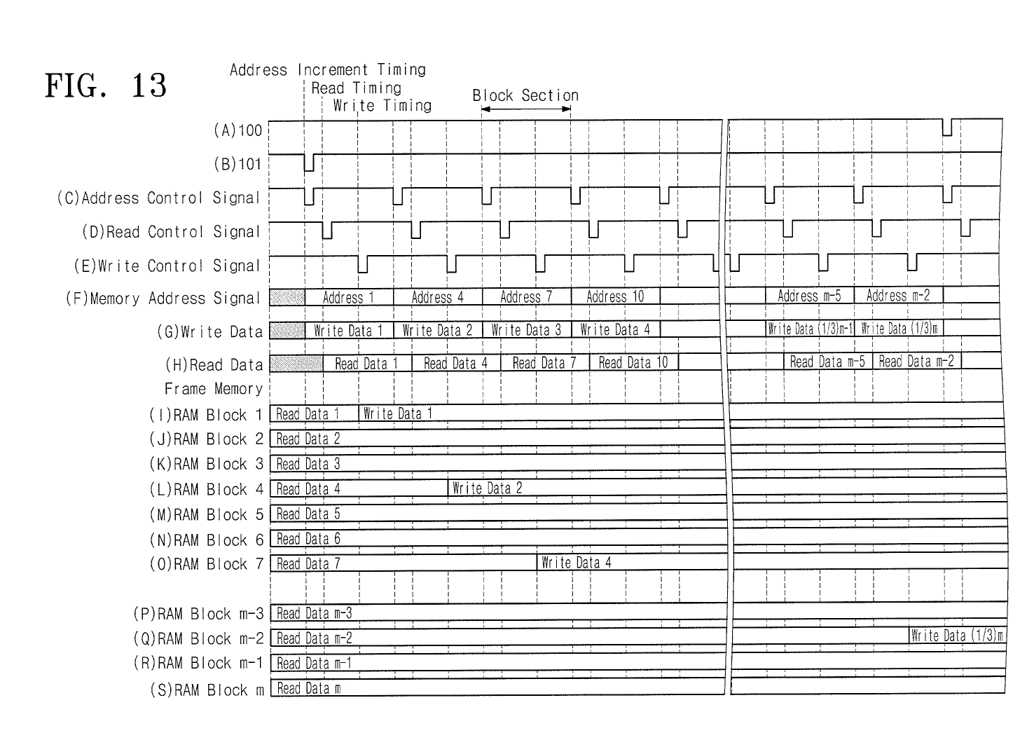

The write and read operations of image data in the display device 20 are described with reference to FIGS. 1, and 13 to 15. FIGS. 13 to 15 are timing charts of examples of a frame memory control operation. The control processing of the write and read operations of image data and the increment processing of an address may be performed by flow charts represented in FIGS. 8 and 9.

The timing control circuit 21 initiates the generation of the address control signal 110 in synchronization with the second vertical synchronization signal 101 (of part (B) of FIG. 13). The address control signal 110 is output to the memory address control circuit 24 (see part (C) of FIG. 13). A plurality of block sections is defined by the address control signal 110.

The memory address control circuit 24 sequentially generates the memory address signals 311, 312, . . . , 31m-2, 31m-1, and 31m represented as a sequential increment in address in synchronization with the address control signal 110 (see part (F) of FIG. 13). The timing of an increment in address by the memory address signals 311, 312, . . . , 31m-2, 31m-1, and 31m is represented as an “address increment timing” in FIG. 13.

An address having an increment by the memory address signal represented in part (F) of FIG. 13 is to display first subfield data and the address is sequentially set to “address 1 -> address 4 -> address 7 -> address 10 -> . . . -> address m-5 -> address m-2”, for example. Address 1, address 4, . . . , address m-5 to address m-2 are sustained for a plurality of block sections, respectively. For example, address 1 is sustained for a first block section and address 4 is sustained for a second block section.

Also, the first subfield data 211 sustained in the first subfield data sustain circuit 23b by the write control circuit 23d in synchronization with the write control signal 111 represented in part (E) of FIG. 13 is sequentially transmitted to the frame memory 25 as the write data 220 (write data 1 to (1/3)m represented in part (G) of FIG. 13).

FIG. 13 represents that read data 1 to m represented in parts (I) to (S) of FIG. 13, read targets is previously written to RAM blocks 1 to m before write data 1 to (1/3)m is sequentially written to RAM block 1, RAM block 4, . . . , RAM block m-5, and RAM block m-2.

Read data 1, read data 4, . . . , read data m-5, and read data m-2 according to address 1, address 4, . . . , address m-5 to address m-2 set by the memory address signals 311, 312, . . . , 31m-2, 31m-1, and 31m among the whole read data 1 to m is sequentially transmitted from RAM block 1, RAM block 4, . . . , RAM block m-5, and RAM block m-2 to the read control circuit 23e. The read control circuit 23e sequentially transmits read data 1, read data 4, . . . , read data m-5, and read data m-2 to the data driving circuit 26 in synchronization with the read control signal 112 represented in part (D) of FIG. 13.

Then, write data 1 to (1/3)m according to address 1, address, 4, . . . , address m-5 to address m-2 set by the memory address signals 311, 312, . . . , 31m-2, 31m-1 31m represented in part (F) of FIG. 13 is sequentially written to RAM block 1, RAM block 4, . . . , RAM block m-5, and RAM block m-2.

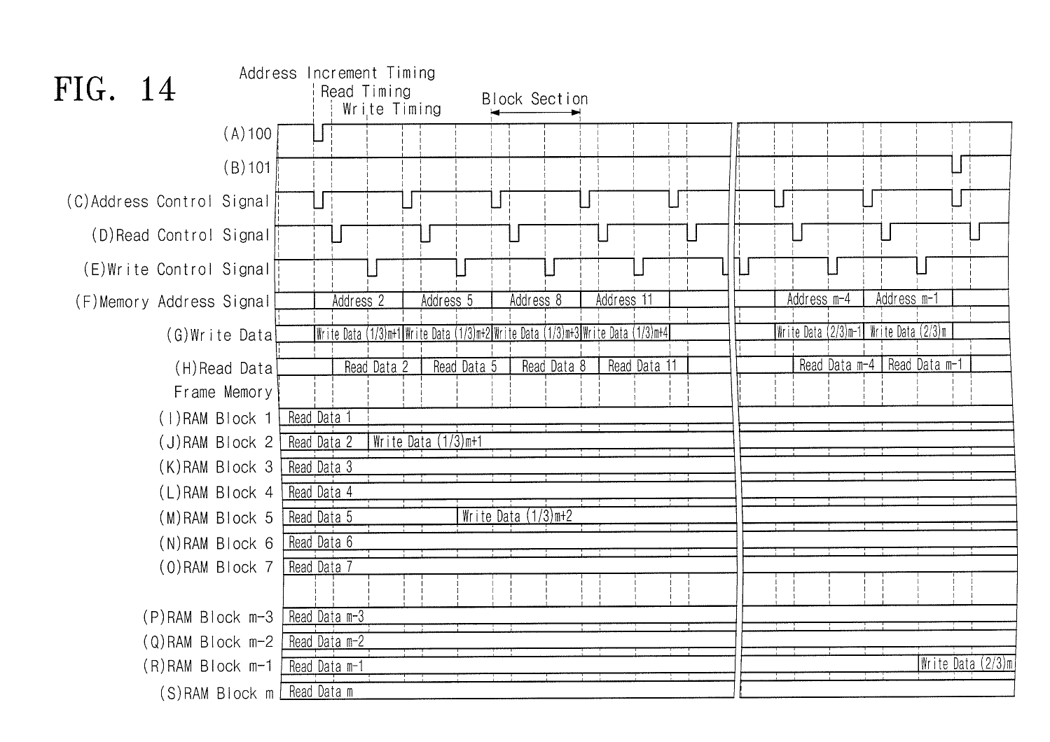

Next, examples of the write and read operations of image data continuous with FIG. 13 are described with reference to the timing charts of FIGS. 1 and 14.

The timing control circuit 21 initiates the generation of the address control signal 110 in synchronization with the second vertical synchronization signal 101 (of part (B) of FIG. 14) (continuously from the state of FIG. 13). The address control signal 110 is output to the memory address control circuit 24 (see part (C) of FIG. 14). A plurality of block sections is defined by the address control signal 110.

The memory address control circuit 24 sequentially generates the memory address signals 311, 312, . . . , 31m-2, 31m-1, and 31m represented as a sequential increment in address in synchronization with the address control signal 110 (see part (F) of FIG. 14). The timing of an increment in address by the memory address signals 311, 312, . . . , 31m-2, 31m-1, and 31m is represented as an “address increment timing” in FIG. 14.

An address having an increment by the memory address signal represented in part (F) of FIG. 14 is to display second subfield data and the address is sequentially set to “address 2 -> address 5 -> address 8 -> address 11 -> . . . -> address m-4 - > address m-1”, for example. Address 2, address 5, . . . , address m-4 to address m-1 are sustained for a plurality of block sections, respectively. For example, address 2 is sustained for a first block section and address 5 is sustained for a second block section.

Also, the second subfield data 212 sustained in the second subfield data sustain circuit 23c by the write control circuit 23d in synchronization with the write control signal 111 represented in part (E) of FIG. 14 is sequentially transmitted to the frame memory 25 as the write data 220 (write data (1/3)m+1 to (2/3)m represented in part (G) of FIG. 14).

FIG. 14 represents that read data 1 to m represented in parts (I) to S of FIG. 14, read targets is previously written to RAM blocks 1 to m before write data (1/3)m+1 to (2/3)m is sequentially written to RAM block 1, RAM block 5, . . . , RAM block m-4, and RAM block m-1.

Read data 2, read data 5, . . . , read data m-4, and read data m-1 according to address 2, address 5, . . . , address m-4 to address m-1 set by the memory address signals 311, 312, . . . , 31m-2, 31m-2, and 31m among the whole read data 1 to m is sequentially transmitted from RAM block 2, RAM block 5, . . . , RAM block m-4, and RAM block m-1 to the read control circuit 23e. The read control circuit 23e sequentially transmits read data 2, read data 5, . . . , read data m-4, and read data m-1 to the data driving circuit 26 in synchronization with the read control signal 112 represented in part (D) of FIG. 14.

Then, write data (1/3)m+1 to (2/3)m according to address 2, address, 5, . . . , address m-4 to address m-1 set by the memory address signals 311, 312, . . . , 31m-2, 31m-1 and 31m represented in part (F) of FIG. 14 is sequentially written to RAM block 2. RAM block 5, . . . , RAM block m-4, and RAM block m-1.

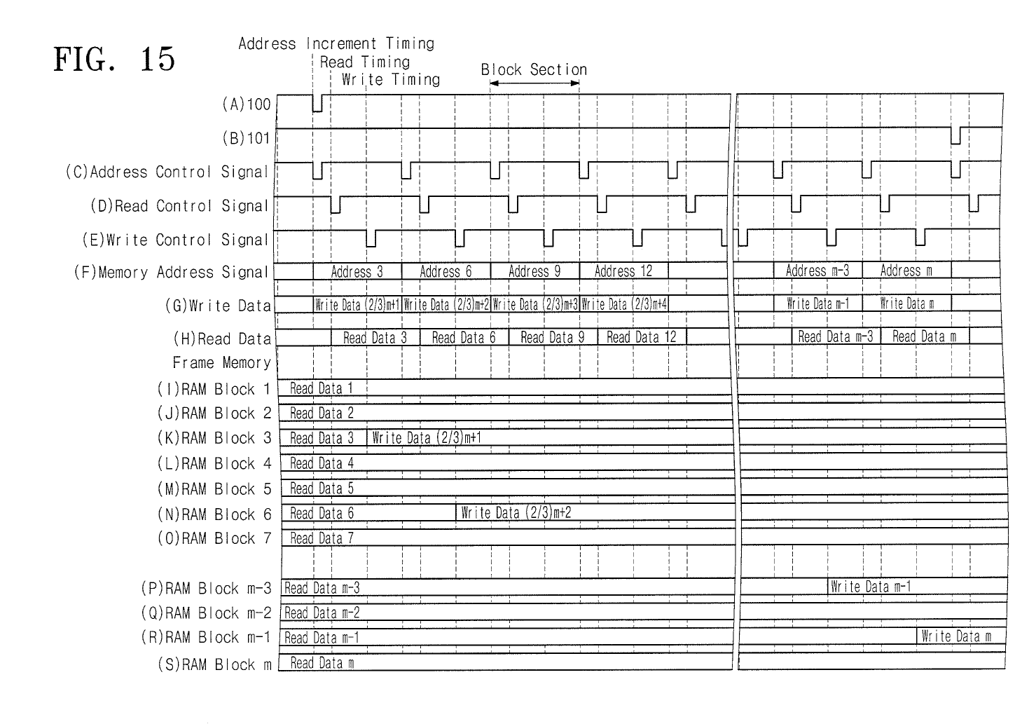

Next, examples of the write and read operations of image data continuous with FIG. 14 are described with reference to the timing charts of FIGS. 1 and 15.

The timing control circuit 21 initiates the generation of the address control signal 110 in synchronization with the second vertical synchronization signal 101 (of part (B) of FIG. 15) (continuously from the state of FIG. 13). The address control signal 110 is output to the memory address control circuit 24 (see part (C) of FIG. 15). A plurality of block sections is defined by the address control signal 110.

The memory address control circuit 24 sequentially generates the memory address signals 311, 312, . . . , 31m-2, 31m-1, and 31m represented as a sequential increment in address in synchronization with the address control signal 110 (see part (F) of FIG. 15). The timing of an increment in address by the memory address signals 311, 312, . . . , 31m-2, 31m-1, and 31 m is represented as an “address increment timing” in FIG. 15.

An address having an increment by the memory address signal represented in part (F) of FIG. 15 is to display third subfield data and the address is sequentially set to “address 3 -> address 6 -> address 9 -> address 12 -> . . . -> address m-3 -> address m”, for example. Address 3, address 6, . . . , address m-3 to address m are sustained for a plurality of block sections, respectively. For example, address 3 is sustained for a first block section and address 6 is sustained for a second block section.

Also, third subfield data sustained in a third subfield data sustain circuit (not shown) by the write control circuit 23d in synchronization with the write control signal 111 represented in part (E) of FIG. 15 is sequentially transmitted to the frame memory 25 as the write data 220 (write data (2/3)m+1 to m represented in part (G) of FIG. 15).

FIG. 15 represents that read data 1 to m represented in parts (I) to (S) of FIG. 15, read 1targets is previously written to RAM blocks 1 to m before write data (2/3)m+1 to m is sequentially written to RAM block 3, RAM block 6, . . . , RAM block m-3, and RAM block m.

Read data 3, read data 6, . . . , read data m-3, and read data m according to address 3, address 6, . . . , address m-3 to address m set by the memory address signals 311, 312, . . . , 31m-2, 31m-1, and 31m among the whole read data 1 to m is sequentially transmitted from RAM block 3, RAM block 6, . . . , RAM block m-3, and RAM block m to the read control circuit 23e. The read control circuit 23e sequentially transmits read data 3, read data 6, . . . , read data m-3, and read data m to the data driving circuit 26 in synchronization with the read control signal 112 represented in part (D) of FIG. 15.

Then, write data (2/3)m+1 to m according to address 3, address, 6, . . . , address m-3 to address m set by the memory address signals 311, 312, . . . , 31m-2, 31m-1 and 31m represented in part (F) of FIG. 15 is sequentially written to RAM block 3. RAM block 6, . . . , RAM block m-3, and RAM block m.

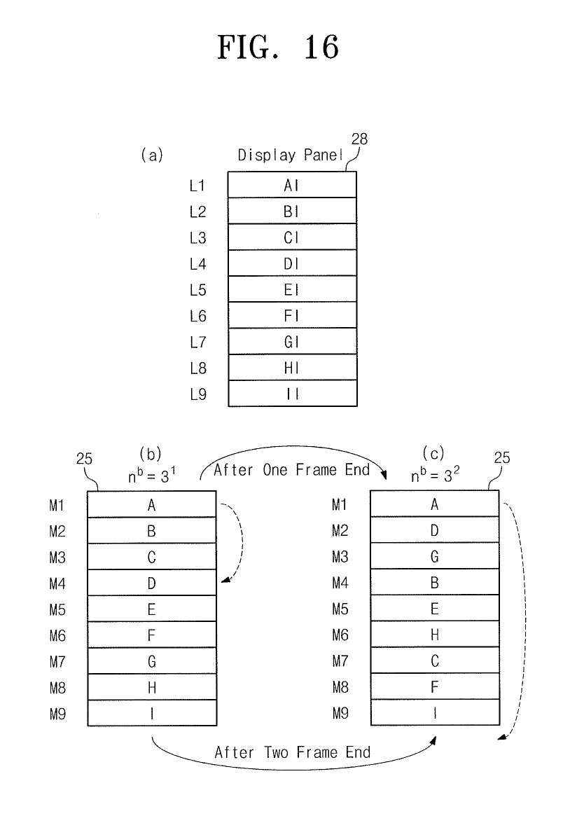

Next, a particular example of the write data 220 (as shown in FIG. 1) that is sequentially written to a RAM block by the increment processing of an address is described with reference to FIGS. 1 and 16. FIG. 16 illustrates the relationship between image data displayed on the display panel 28 and the write state of write data to be written to a RAM block. For the simplicity of description, FIG. 16 represents that nine pixel addresses are provided with the display panel 28 and nine RAM blocks are provided. Also, the number of subfields n is set to 3.

The pixel addresses L1 to L9 of the display panel 28 are set in part (A) of FIG. 16 and addresses M1 to M9 are set for each RAM block of the frame memory 25 in parts (B) and (C) of FIG. 16. Images AI to HI are displayed on the pixel addresses L1 to L9 of the display panel 28. In order to display images AI to II, write data A to I is previously written to each RAM block corresponding to each of addresses M1 to M9 having an increment by the address increment processing.

Write data A to I corresponds to images AI to II, respectively. Write data A, D and G is the write data of a first subfield, write data B, E, and H is the write data of a second subfield, and write data C, F, and I is the write data of a third subfield.

First, since the frame count b is 1, the increment n^{b} becomes 3¹ and the address N_{ad} increases by 3. Therefore, write data A, D, and G of the first subfield is sequentially read from addresses Ml, M4, and M7, and write data A to C of the next frame is written to addresses M1, M4, and M7.

Then, write data B, E and H of the first subfield is sequentially read from addresses M2, M5, and M8, and write data D to F of the next frame is written to addresses M2, M5, and M8.

Then, write data C, F and I of the first subfield is sequentially read from addresses M3, M6, and M9, and write data G to I of the next frame is written to addresses M3, M6, and M9. Accordingly, write data corresponding to one frame is read. In this state, each RAM block has a state as represented in part (C) of FIG. 16.

Then, since the process transits to the next frame b=2, the increment n^{b} becomes 3². In this state, data corresponding to addresses M1 to M9 is sequentially read and when the write data of the next frame is written, the process returns to a state that part (B) of FIG. 16 has. In this case, the write state transition of write data relative to nine RAM blocks is repeated among two states in parts (B) and (C) of FIG. 16. In this example, the frame memory 25 is enough to have capacity corresponding to one frame. In this case, it is possible to decrease capacity to 1/2 compared when capacity corresponding to two frames is needed.

In the above-described example, when the number of subfields n is 3, the read and write processing of image data and the increment processing of an address represented in FIGS. 8 and 9 are used to perform the read and write operations of image data when the number of pixel addresses L1 to L9 is 9 and the number of RAM blocks is 9. Thus, since the frame memory 25 is enough to have capacity corresponding to one frame, the capacity of the frame memory 25 decreases to 1/2 of typical capacity.

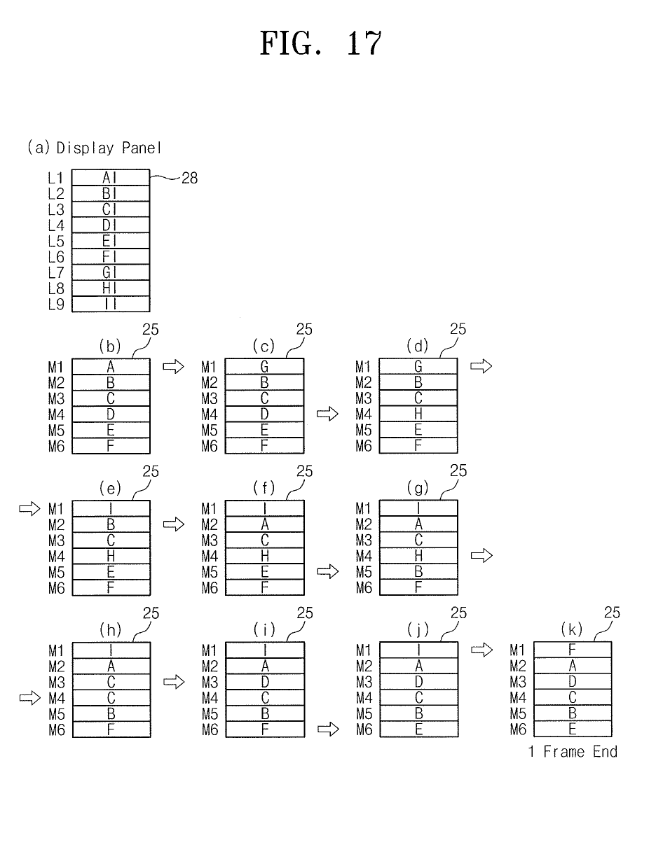

In this case, it is implemented without delaying the second vertical synchronization signal 101 by 1-(1/n) frame period (2/3 frame period in this example) than a first vertical synchronization signal. When it is assumed that the second vertical synchronization signal 101 is delayed by 1-(1/n) frame period (2/3 frame period in this example) than the first vertical synchronization signal, it is possible to decrease the capacity of the frame memory 25 to 1-(1/n) (2/3 in this example) by taking the number of RAM blocks as six by using the delay. In the following, when the number of subfields n is 3, an example of performing the read and write operations of image data by setting the number of pixel addresses L1 to L9 of the display panel 28 to 9 and the number of RAM blocks to 6 is described with reference to FIG. 17.

FIG. 17 illustrates the relationship between image data displayed on the display panel and write data written to six RAM blocks. For the simplicity of description, FIG. 17 represents when the number of the pixel addresses L1 to L9 of the display panel 28 is 9 and the number of RAM blocks is 6. Also, the number of subfields n is set to 3.

The pixel addresses L1 to L9 of the display panel 28 are set in part (A) of FIG. 17 and addresses M1 to M9 are set for each RAM block of the frame memory 25 in parts (B) to (K) of FIG. 17. Images AI to II are displayed on the pixel addresses L1 to L9 of the display panel 28. In order to display the images, firstly, data A to F is sequentially written to each RAM block corresponding to each of addresses M1 to M6.

Write data A to I corresponds to images AI to II, respectively. Write data A, D, and G is the write data of a first subfield, write data B, E, and H is the write data of a second subfield, and write data C, F, and I is the write data of a third subfield.

First, the write data of the first subfield is read. More particularly, write data A is read from address M1 in part (B) of FIG. 17 and write data G of the same frame is written to address M1. In this state, each RAM block has a state as represented in part (C) of FIG. 17.

Then, write data D is read from address M4 in part (C) of FIG. 17 to which write data D of the first subfield has been written, and write data H of the same frame is written to address M4. In this state, each RAM block has a state as represented in part (D) of FIG. 17.

Then, write data G is read from address M1 in part (D) of FIG. 17 to which write data G of the first subfield has been written, and write data I of the same frame is written to address M1. In this state, each RAM block has a state as represented in part (E) of FIG. 17. As such, data A, D, and G corresponding to the first subfield is read.

Subsequently, the write data of the second subfield is read. More particularly, write data B is read from address M2 in part (E) of FIG. 17 to which write data B of the second subfield has been written, and write data A of the next frame is written to address M2. In this state, each RAM block has a state as represented in part (F) of FIG. 17.

Then, write data E is read from address M5 in part (F) of FIG. 17 to which write data E of the second subfield has been written, and write data B of the next frame is written to address M5. In this state, each RAM block has a state as represented in part (G) of FIG. 17.

Then, write data H is read from address M4 in part (G) of FIG. 17 to which write data H of the second subfield has been written, and write data C of the next frame is written to address M4. In this state, each RAM block has a state as represented in part (H) of FIG. 17. As such, write data B, E, and H corresponding to the second subfield is read.

Then, the write data of the third subfield is read. More particularly, write data C is read from address M3 in part (H) of FIG. 17 to which write data C of the third subfield has been written, and write data D of the next frame is written to address M3. In this example, data C has also been written to address M4 but write data is read from address M3 to which data C of the preceding frame has been written. In this state, each RAM block has a state as represented in part (I) of FIG. 17.

Then, write data F is read from address M6 in part (I) of FIG. 17 to which write data F of the third subfield has been written, and write data E of the next frame is written to address M6. In this state, each RAM block has a state as represented in part (J) of FIG. 17.

Then, write data I is read from address M1 in part (J) of FIG. 17 to which write data I of the third subfield has been written, and write data F of the next frame is written to address M1. In this state, each RAM block has a state as represented in part (K) of FIG. 17. As such, data C, F, and I corresponding to the third subfield is read. Accordingly, write data corresponding to one frame is read.

Then, even though the process transits to the next frame, write data A, D, and G of the first subfield, write data B, E, and H of the second subfield, and write data C, F, and I of the third subfield are sequentially read as described above. In addition, whenever a read operation is performed, write data A to I of the next frame is sequentially written to a RAM block corresponding to an address from which write data is read.

More particularly, when the first frame count is 1, data written to six RAM blocks transits in the order represented in FIG. 17. Also, the order in which write data is written to six RAM blocks properly transits with a change in frame count number, and when the read and write operations of write data of one frame are completed, the process return to a state in which write data A to F is written.

As such, by delaying the second vertical synchronization signal 101 by 1-(1/n) frame period (2/3 frame period in this example) than a first vertical synchronization signal, it is possible to decrease the capacity of a frame memory to 1-(1/n) (2/3 in this example).

As above, the display device 20 according to the present embodiment sequentially controls the increment processing of an address, the read processing of write data and the write processing of write data and sets, in common, an address setting read and write operations for the control. Accordingly, it is possible to divide image data on a subfield basis and share a RAM block for the read and write operations of each subfield data obtained through division and it is possible to perform a write operation immediately after completing a read operation with respect to each RAM block. By such memory control, it is possible to decrease frame memory capacity to 1/2.

Also, it is possible to avoid the overtaking situation of an address by synchronizing the first vertical synchronization signal 100 with the second vertical synchronization signal 101 in frame period and delaying the second vertical synchronization signal 101 by 1-(1/n) frame period (2/3 frame period) than the first vertical synchronization signal 100.

Also, it is possible to efficiently use a frame memory region and as a result, it is possible to decrease the necessary capacity of the frame memory 25. By the delay control, it is possible to decrease the capacity of the frame memory 25 to 1-(1/n)(2/3 where n=3).

The increment processing of an address, data read processing and data write processing according to the present embodiment may be applied to a field sequential driving method in which one frame is divided and driven into three subfields. By performing processing on the frame memory 25, frame memory capacity according to the present embodiment may decrease to capacity corresponding to a 2/3 frame through the above-described memory control and delay control. On the contrary, other configurations need memory capacity corresponding to two frames. Therefore, the display device 20 according to the present embodiment may decrease the frame memory capacity to up to 1/3 compared with these other configurations.

### Variation

The aforementioned embodiments may be applied when a field sequential driving method is used. According to a variation, a method of controlling a memory frame may be applied to other display driving methods, such as an interlace driving method as well as other display driving methods of image data.

Also, the aforementioned embodiments may apply when the number of subfields n is 2 and 3. According to one variation, one frame may be divided into more subfields. In this case, when the second vertical synchronization signal 101 is delayed by 1-(1/n) frame period than the first vertical synchronization signal, it is possible to more efficiently use the frame memory 25 even if n has a greater value, and it is possible to decrease the capacity of the frame memory 25 to 1-(1/n).

Also, the aforementioned embodiments delay the vertical synchronization signal 101 by 1-(1/n) frame period than the first vertical synchronization signal. According to a variation, it is possible to delay the vertical synchronization signal by a period shorter than 1-(1/n) frame period. Even in this case, it is possible to decrease the necessary capacity of the frame memory 25 by setting an address for a data write operation and an address for a data read operation in common, reading data from a set address and then writing data to an address set in common. Through the foregoing embodiments, it may be possible to avoid the overtaking situation of an address and decrease the necessary capacity of a frame memory.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments described herein.

By way of summation and review, in a field sequential driving method, the write timing of image data stored in a frame memory is different from the read timing thereof, so a read address overtakes a write address. When such an overtaking situation occurs, there is a limitation in that a portion of an image of another frame is displayed within the same frame and thus the quality of a displayed image deteriorates.

A variety of methods have been developed in attempt to avoid an overtaking situation. One method involves detecting a difference between the reset time of the write address of a frame memory and the reset timing of the read address of the frame memory. The time difference is then used as a basis of determining whether an overtaking situation has occurred. When the overtaking situation is determined to have occurred, the writing of all pieces of data corresponding to one frame to the frame memory is stopped to avoid deterioration in image quality due to the overtaking situation. Also, in order to avoid the overtaking situation, the display device includes a frame memory corresponding to two frames. However, since the display device used in this method needs a frame memory corresponding to two frames, the cost of the display device increases.

Another method involves dividing a frame memory region into most significant bit (MSB) gradation data and least significant bit (LSB) gradation data, and alternately performing write and read operations of the MSB data through two MSB memory regions for the MSB data. This method also uses a LSB memory region for the LSB data to share the write and read operations of the LSB data. Thus, deterioration in image quality by the overtaking situation decreases and frame memory capacity decreases. However, in this method, a decrease in frame memory capacity is only applied to LSB, so the effect is minimal. Also, since the MSB frame memory still experiences the overtaking situation, it is difficult to avoid deterioration in image quality.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A control circuit for a frame memory, comprising:
a division circuit to divide image data into a plurality of subfield data according to a plurality of subfields, the image data to be provided in synchronization with a first synchronization signal and in a unit of a frame;
a frame memory having a plurality of blocks to which the subfield data is to be written;
a read control circuit to sequentially read the subfield data from the blocks in synchronization with a second synchronization signal, the second synchronization signal having substantially a same cycle as the first synchronization signal and delayed by a preset delay time; and
a write control circuit to write new data to a first block among the plurality of blocks before data written in a second block among the plurality of blocks is read, and after data written in the first block is read by the read control circuit.

2. The control circuit as claimed in claim 1, wherein the preset delay time is 1-(1/n) frame period, where n is the number of subfields.

3. The control circuit as claimed in claim 1, wherein a number of the plurality of blocks is based on a power of n, where n is the number of subfields.

4. The control circuit as claimed in claim 1, wherein the second synchronization signal is generated from the first synchronization signal.

5. A display device, comprising:
a division circuit to divide image data into a plurality of subfield data according to a plurality of subfields, the image data to be provided in synchronization with a first synchronization signal and in a unit of a frame;
a frame memory having a plurality of blocks to which the subfield data is to be written;
a read control circuit to read data corresponding to one frame in synchronization with a second synchronization signal, the second synchronization signal having substantially a same cycle as the first synchronization signal and is delayed by a preset delay time, the read control circuit to read the data in a predetermined sequence;
a write control circuit to write the subfield data to a first block of the plurality of blocks after the image data is read from the first block by the read control circuit; and
a driving circuit to drive a pixel of a display panel based on image data read by the read control circuit.

6. The display device as claimed in claim 5, wherein the preset delay time is 1-(1/n) frame period, where n is the number of subfields.

7. The display device as claimed in claim 5, wherein a number of the plurality to blocks is based on a power of n, where n is the number of subfields.

8. The display device as claimed in claim 5, wherein the second synchronization signal is generated from the first synchronization signal.

9. A method of controlling a frame memory, the method comprising:
dividing image data into a plurality of subfield data according to a plurality of subfields, the image data provided in synchronization with a first synchronization signal and in a unit of a frame;
sequentially reading the subfield data from a plurality of blocks of a frame memory in synchronization with a second synchronization signal, the second synchronization signal having substantially a same cycle as the first synchronization signal and delayed by a preset delay time; and
writing new data to a first block among the plurality of blocks before data written to a second block among the plurality of blocks is read, and after image data written to the first block is read.

10. The method as claimed in claim 9, wherein the preset delay time is 1-(1/n) frame period, where n is the number of subfields.

11. The method as claimed in claim 9, wherein a number of the plurality of blocks of the frame memory is based on a power of n, where n is the number of subfields.

12. A control circuit for a frame memory, comprising:
a frame memory having a plurality of blocks to store subfield data;
a read control circuit to read the subfield data from the blocks in synchronization with a second synchronization signal, the second synchronization signal delayed by a preset delay time relative to a first synchronization signal to control writing of the subfield data in the blocks; and
a write control circuit to write new data to a first block among the plurality of blocks before data written in a second block among the plurality of blocks is read, and after data written in the first block is read by the read control circuit.

13. The control circuit as claimed in claim 12, wherein the second synchronization signal has substantially a same cycle as a first synchronization signal.

14. The control circuit as claimed in claim 12, further comprising:
a divider to divide image data into the subfield data according to a plurality of subfields, the image data to be provided in synchronization with the first synchronization signal and in a unit of a frame.

15. The control circuit as claimed in claim 12, wherein the preset delay time is 1-(1/n) frame period, where n is the number of subfields.

16. The control circuit as claimed in claim 12, wherein a number of the plurality to blocks is based on a power of n, where n is the number of subfields.

17. The control circuit as claimed in claim 12, wherein the second synchronization signal is generated from the first synchronization signal.

18. The control circuit as claimed in claim 12, wherein the read control circuit is to sequentially read the data of the subfield data.

19. The control circuit as claimed in claim 12, further comprising:
an address control circuit to set a common address for a data write operation and a data read operation for one of the blocks.

20. The control circuit as claimed in claim 19, wherein the read control circuit is to read data from the one of the blocks and the write control circuit is to write data to the one of the blocks based on the common address.
